(19) United States
(12) Patent Application Publication
(10) Pub. No.: US 2012/0250241 A1
(43) Pub. Date: Oct. 4, 2012

(54) INFORMATION PROCESSING APPARATUS AND INFORMATION PROCESSING METHOD

(76) Inventors: Takashi MINEMURA, Ome-shi (JP); Hiromichi SUZUKI, Hamura-shi (JP); Yuji NAKAJIMA, Nishitama-gun (JP)

(21) Appl. No.: 13/431,714

(22) Filed: Mar. 27, 2012

(30) Foreign Application Priority Data
Mar. 30, 2011 (JP) 2011-076419
Aug. 26, 2011 (JP) 2011-185205

(51) Int. Cl. G06F 1/16

(52) U.S. Cl. 361/679.21; 361/679.02

(57) ABSTRACT

According to one embodiment, an information processing apparatus includes a connection member, a first casing, a second casing, and a display panel. The first casing is connected to the connection member turnably around a first axis. The second casing is connected to the connection member turnably around a second axis parallel to the first axis. The display panel is provided on the first casing and configured to display an image according to both of a first turning angle of the first casing with respect to the connection member and a second turning angle of the second casing with respect to the connection member.

### CROSS REFERENCE TO RELATED APPLICATION(S)

This application is based upon and claims the benefit of priorities from Japanese Patent Application No. 2011-076419 filed on Mar. 30, 2011 and Japanese Patent Application No. 2011-185205 filed on Aug. 26, 2011, the entire contents of which are incorporated herein by reference.

### FIELD

Embodiments described herein relate generally to an information processing apparatus and an information processing method.

### BACKGROUND

In each of laptop computers and folding mobile phones, two casings are connected to each other by a hinge or the like. A display screen is provided on one of the two casings. The connection configuration of the two casings includes, e.g., a single-axis hinge configuration in which two casings are connected to each other by a single-axis hinge, and a two-axis hinge configuration in which one of the two casings is connected to a connection casing by one-axis hinge, and in which the connection casing and the other casing are connected to each other by another-axis hinge.

If the two casings are connected to each other by a connection component such as a hinge, it is favorable that preferred processing can be performed according to an opening angle of each of the casings.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIGS. 1A to 1C are exemplary diagrams illustrating an external-appearance of a computer according to an embodiment;

FIGS. 2A and 2B are exemplary diagrams illustrating a connection mechanism of the computer according to the embodiment;

FIG. 3 is an exemplary diagram illustrating a system configuration of the computer according to the embodiment;

FIG. 4 is an exemplary diagram illustrating a function block of the computer according to the embodiment;

FIGS. 5A and 5B are exemplary diagrams illustrating a screen displayed by the system configuration of the computer according to the embodiment;

FIGS. 6A and 6B are exemplary diagrams illustrating the screen displayed by the system configuration of the computer according to the embodiment;

FIG. 7 is an exemplary diagram illustrating a flow of a screen display processing by the computer according to the embodiment;

FIGS. 8A to 8C are exemplary diagrams illustrating an external-appearance and the mechanism of a computer according to another embodiment; and

FIG. 9 is an exemplary diagram illustrating a flow of a screen display processing by the computer according to the other embodiment.

### DETAILED DESCRIPTION

In general, according to one embodiment, an information processing apparatus includes a connection member, a first casing, a second casing, and a display panel. The first casing is connected to the connection member turnably around a first axis. The second casing is connected to the connection member turnably around a second axis parallel to the first axis. The display panel is provided on the first casing and configured to display an image according to both of a first turning angle of the first casing with respect to the connection member and a second turning angle of the second casing with respect to the connection member.

Hereinafter, exemplary embodiments are described with reference to the accompanying-drawings.

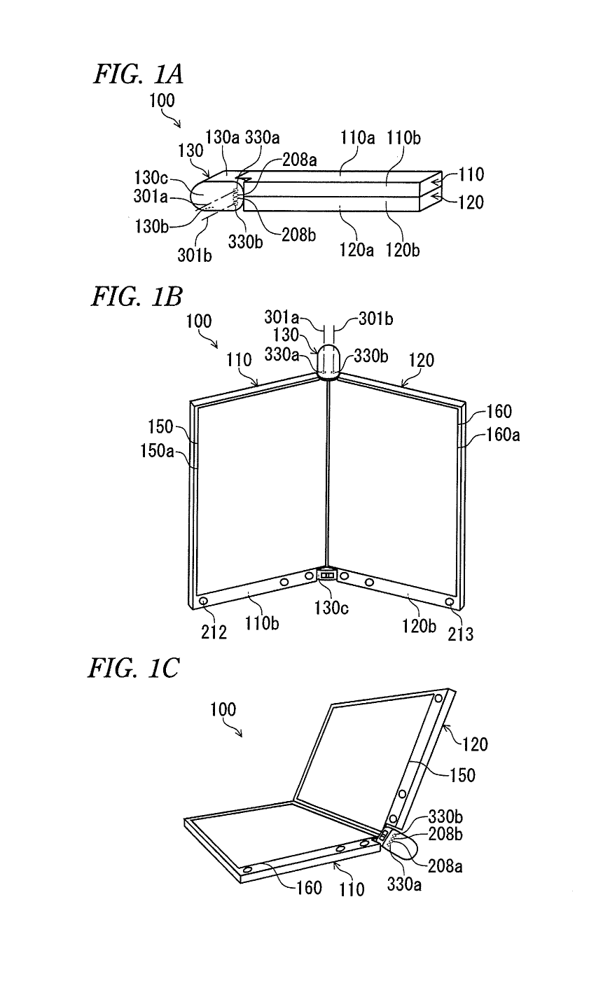

FIGS. 1A to 1C are diagrams illustrating an example of the external-appearance of an information processing apparatus according to the embodiment. The information processing apparatus according to the present embodiment is implemented as, e.g., a folding computer 100. The computer 100 includes a first casing 110, a second casing 120, a connection member 130, a first display panel 150, a first touch panel 150a, a second display panel 160, and a second touch panel 160a.

The first casing 110 and the second casing 120 are connected to each other here via the connection member 130. That is, the first casing 110 and the connection member 130 are turnably connected to each other via a shaft 330a centered on an axis 301a. The second casing 120 and the connection member 130 are turnably connected to each other via a shaft 330b centered on an axis 301b. The connection member 130 has a side surface portion 130a connected to an outer surface 110a of the first casing 110 when the first casing 110 is in a closed state with respect to the connection member 130. The connection member 130 also has a side surface portion 130b connected to an outer surface 120a of the second casing 120 when the second casing 120 is in a closed state with respect to the connection member 130. The connection member 130 has a shape extending in a direction away from the first casing 110 and the second casing 120 when the first casing 110 and the second casing 120 are in a closed state as illustrated in FIG. 1A.

The first display panel 150 is provided on a surface of the first casing 110, which faces the second casing 120 when the first casing 110 and the second casing 120 are closed. The first touch panel 150a is provided to be superposed on the first display panel 150. The first display panel 150 displays an image, and the first touch panel 150a detects and receives a touch operation input, from outside the computer 100, on an image displayed on the first display panel 150. The second display panel 160 is provided on a surface of the second casing 120, which faces the first casing 110 when the first casing 110 and the second casing 120 are closed. The second touch panel 160a is provided to be superposed on the second display panel 160. The second display panel 160 displays an image, and the second touch panel 160a detects and receives a touch operation input, from outside the computer 100, to an image displayed on the second display panel 160.

The first casing 110 is provided with a power button 212 for receiving power on/off operations to be performed on the computer 100. The second casing 120 is provided with a mode switching button 213 for receiving a display mode switching operation to be performed on the computer 100. The mode switching button 213 is described below.

The first casing 110 and the second casing 120 can assume various angles with respect to the connection member 130. For example, the first casing 110 and the second casing 120 can have a state in which the first casing 110 and the second casing 120 are closed as illustrated in FIG. 1A, a state in which each of the first casing 110 and the second casing 120 is opened at substantially the same angle with respect to the connection member 130 as illustrated in FIG. 1B, and a state in which the first casing 110 and the second casing 120 are opened at different angles, respectively, as illustrated in FIG. 1C. The computer 100 brought into the state illustrated in FIG. 1B has a structure in which an end portion 110b of the first casing 110, an end portion 120b of the second casing 120, and an end portion 130c of the connection member 130 have contact with a flat surface of an external installation place.

A connection mechanism 300 (not shown in FIGS. 1A to 1C) connecting the first casing 110 and the connection member 130 to each other is provided with an angle detecting module 208a detecting an opening angle of the first casing 110 with respect to the connection member 130. Similarly, the connection mechanism 300 connecting the second casing 120 and the connection member 130 to each other is provided with an angle detecting module 208b detecting an opening angle of the second casing 120 with respect to the connection member 130. That is, the angle detecting modules 208a and 208b can detect various opened states of the first casing 110 and the second casing 120 respectively illustrated in FIGS. 1A to 1C.

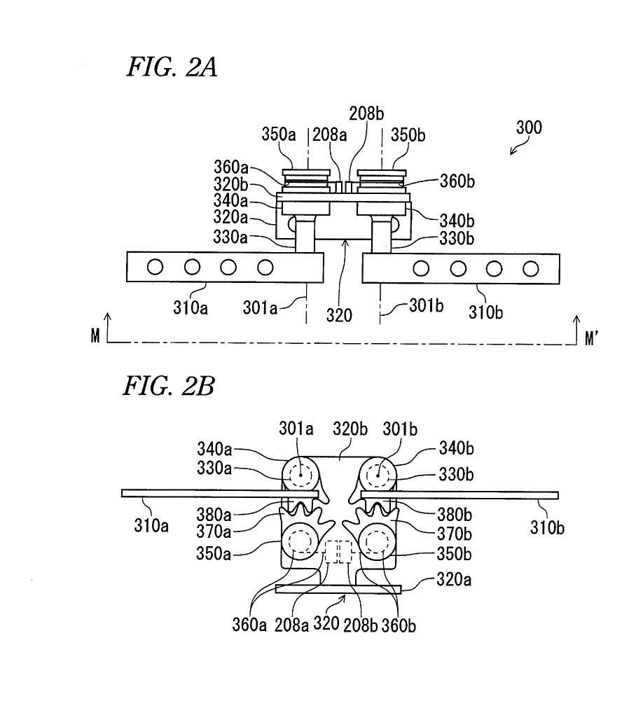

Next, the connection mechanism 300 connecting each of the first casing 110 and the second casing 120 to the connection member 130 is described hereinafter with reference to FIGS. 2A and 2B. The connection mechanism 300 includes a base 310a, a base 320, the shaft 330a, a cap 340a, a cap 350a, a spring 360a, a gear 370a, a gear 380a, a base 310b, the shaft 330b, a cap 340b, a cap 350b, a spring 360b, a gear 370b, and a gear 380b.

First, the configuration of a part thereof at the side of the first casing 110 is described hereinafter. The base 310a is fixed to the first casing 110, while the base 320 is fixed to the connection member 130. The base 320 includes a fixed part 320a fixed to the connection member 130, and an erected part 320b erected from the fixed part 320. The shaft 330a is fixed to the base 310a and connected to the erected part 320b to be turnable around the axis 301a. The cap 340a is attached to an end of the shaft 330a, which is at the side of the erected part 320b.

The cap 350a is turnably provided on the erected part 320b. A coil spring 360a is wound around the cap 350a. The coil spring 360a is fixed to the cap 350a at an end thereof and to the angle detecting module 208a at the other end thereof.

The gear 380a is fixed to the cap 340a, while the gear 370a is fixed to the cap 350a. The gears 370a and 380a are provided to mesh with each other. That is, when the first casing 110 turns around the axis 301a, a force of the turn is transmitted to the gear 370a by the gear 380a, which is connected to the base 310a connected to the first casing 110. Then, when the cap 350a connected to the gear 370a turns, a pressure depending on a turning angle of the base 310a is added to the angle detecting module 208a connected via the coil spring 360a to the cap 350a. The turning angle of the base 310a, i.e., the turning angle of the first casing 110 around the axis 301a is detected by detecting the pressure.

The configuration of a part thereof at the side of the second casing 120 is described hereinafter. The base 310b is fixed to the second casing 120. The base 320 is fixed to the connection member 130. The shaft 330b is fixed to the base 310b, and connected to the erected part 320b to be turnable around the axis 301a of the first casing 110. The cap 340b is attached to an end of the shaft 330b, which is at the side of the erected part 320b.

The cap 350b is turnably provided on the erected part 340b. The coil spring 360b is wound around the cap 350b. An end of the coil spring 360b is fixed to the cap 350b, while the other end thereof is fixed to the angle detecting module 208b. The gear 380b is fixed to the cap 340b, while the gear 370b is fixed to the cap 350b. The gears 370b and 380b are provided to mesh with each other.

That is, when the second casing 120 turns around the axis 301b, a force of the turn is transmitted to the gear 370b by the gear 380b connected to the base 310b that is connected to the second casing 120. When the cap 350b connected to the gear 370b turns, a pressure depending on the turning angle of the base 310b is added to the angel detecting module 208b connected via the coil spring 360b to the cap 350b. The angle detecting module 208b detects the turning angle of the base 310b, i.e., the turning angle of the second casing 120 around the axis 301b by detecting the pressure. Incidentally, while the power of the computer 100 is turned on, the angle detecting module 208 (208a, 208b) can always detect the angle. However, the angle detecting module 208 can detect the angle at every certain period, e.g., several milliseconds. For example, the angle detecting module 208 can stop the detection of the angle after a certain period elapses since the turning angle is changed. When the angle is changed again, the angle detecting module 208 can restart the detection of the angle.

Although FIGS. 2A and 2B illustrate the configuration in which the turning angle of each of the first casing 110 and the second casing 120 is detected according to, e.g., the pressure, the configuration for detecting the angle is not limited thereto. For example, a magnetic material is applied to the shaft 330a to generate a magnetic field whose magnitude varies according to an angle around the axis 301a. In addition, a sensor for detecting a magnetic field is provided in the vicinity of the shaft 330a. Thus, the sensor can detect a magnetic field whose magnitude varies according to the turning angle of the shaft 330a.

The connection mechanism 300 can be configured to change the wire diameters and the like of the coil springs 360a and 360b such that the resistance torque at the time of turning the first casing 110 with respect to the connection member 130 differs from that at the time of turning the second casing 120 with respect to the connection member 130.

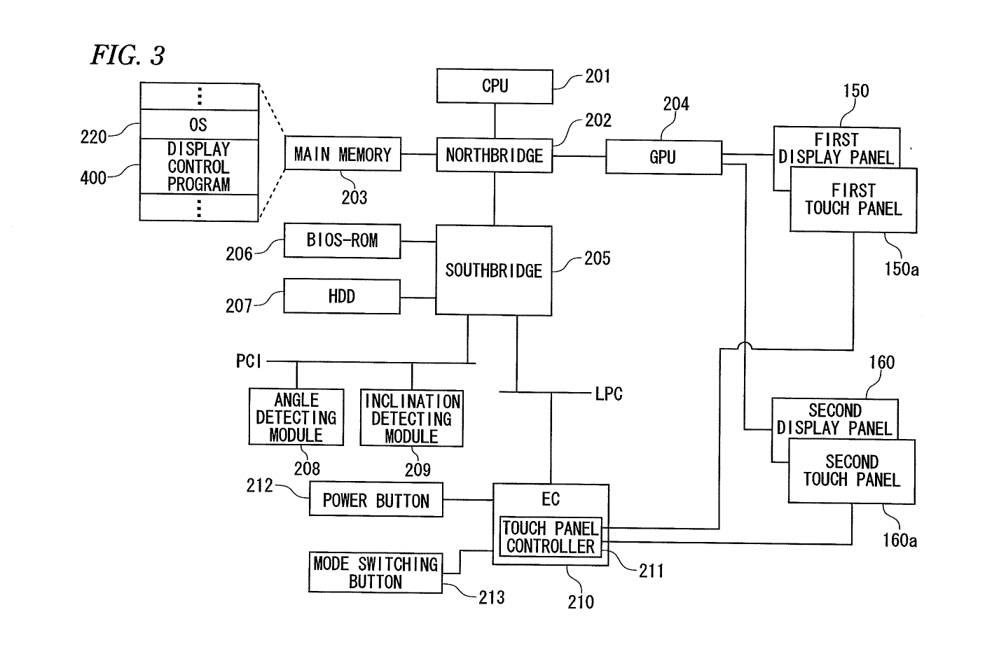

Next, an example of the system configuration of the computer 100 is described with reference to FIG. 3. The computer 100 includes a central processing unit (CPU) 201, a northbridge 202, a main memory 203, a graphics processing unit (GPU) 204, a southbridge 205, a basic input/output system (BIOS)-read-only memory (ROM) 206, a hard disc drive (HDD) 207, an angle detecting module 208, an inclination detecting module 209, an embedded controller (EC) 210, a touch panel controller 211, the power button 212, the mode switching button 213, the first display panel 150, the first touch panel 150a, the second display panel 160, and the second touch panel 160a.

The CPU 201 has the function of controlling an operation of the computer 100. The CPU 201 reads various programs, such as an operating system (OS) 220 and a display control program 400, to the main memory 203 and executes the programs. The display control program 400 is described below with reference to FIGS. 3 to 7.

The northbridge 202 is a bridge device connecting the CPU 201 and the southbridge 205 to each other. The northbridge 202 incorporates a memory controller controlling the main memory 203. In addition, the northbridge 202 has the function of communicating with the GPU 204 and causes the GPU 204 to perform image processing according to an instruction from the CPU 201.

The GPU 204 operates as a display controller for the first display panel 150 and the second display panel 160 serving as display devices of the computer 100. The GPU 204 converts video data input from the CPU 201 into video signals in a format displayable by display devices such as the display panels 150 and 160. Then, the GPU 204 outputs the video signals to the display panels 150 and 160. The display panels 150 and 160 displays video images according to the video signals output from the GPU 204.

The southbridge 205 functions as a controller for each device on a peripheral component interconnect (PCI) bus, and various devices on a low pin count (LPC) bus. The BIOS-ROM 206, the HDD 207 and the like are connected to the southbridge 205. The southbridge 205 incorporates an integrated drive electronics (IDE) controller controlling the HDD 207.

The BIOS-ROM 206 stores BIOS serving as a program for controlling hardware of the computer 100. The HDD 207 is a storage medium storing various programs, such as an operating system (OS) 220 or a display control program 400. The HDD 207 stores image data of a photograph and the like.

The angle detecting module 208 and the inclination detecting module 209 are connected to the southbridge 205 via the PCI bus. The angle detecting module 208 is, e.g., the above angle detecting modules 208a and 208b, and detects the angle of turn of the first casing 110 and the second casing 120. The inclination detecting module 209 detects the inclination of the computer 100 with a gyrosensor.

The EC 210 is connected to the southbridge 205 via the LPC bus. The EC 210 includes a touch panel controller 211 controlling the first touch panel 150a and the second touch panel 160a, and a button controller (not shown) controlling various buttons, such as the power button 212 and the mode switching button 213. The first touch panel 150a, the second touch panel 160a, the power button 212, and the mode switching button 213 receive various operation inputs from outside the computer 100. The EC 210 outputs operation input signals to the CPU 201.

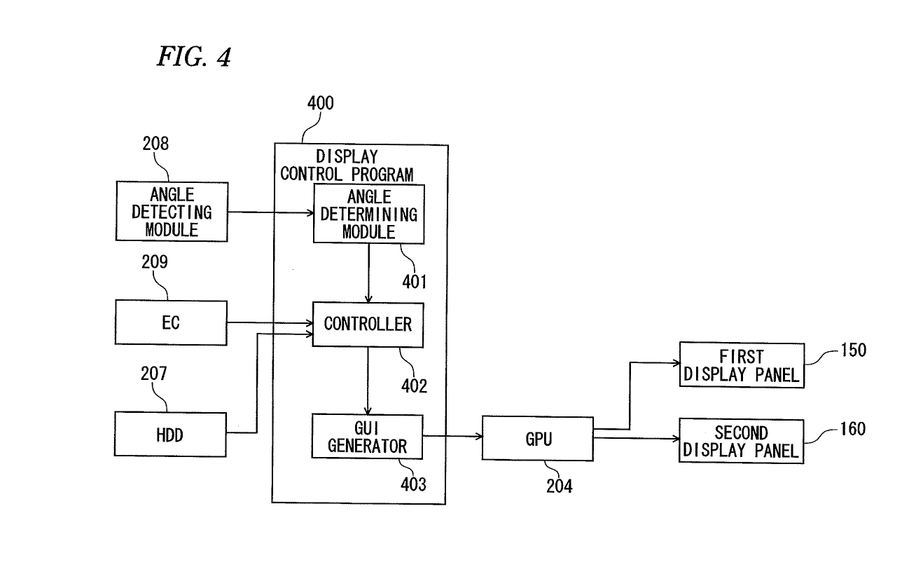

Next, with referring to FIG. 4, the functional configuration of the display control program 400 is described hereinafter. The display control program 400 includes an angle determining module 401, a controller 402, and a graphic user interface (GUI) generator 403.

Angle information is input from the angle detecting module 208 to the angle determining module 401. The angle information is information concerning the angle of turn of each of the first casing 110 and the second casing 120. The angle determining module 401 determines, based on the angle information, by what angle each of the first casing 110 and the second casing 120 turns. Incidentally, the angel determining module 401 is assumed to determine an opening angle from the closed state of each of the first casing 110 and the second casing 120 by setting the angle in the closed state of each of the casings 110 and 120 at 0.

The angle determining module 401 determines, e.g., whether a sum of the opening angles of the first casing 110 and the second casing 120 is equal to or more than a certain angle, and whether the difference in opening angle between the first casing 110 and the second casing 120 is equal to or more than a certain angle. Then, the angle determining module 401 outputs to the controller 402 a result of such determination.

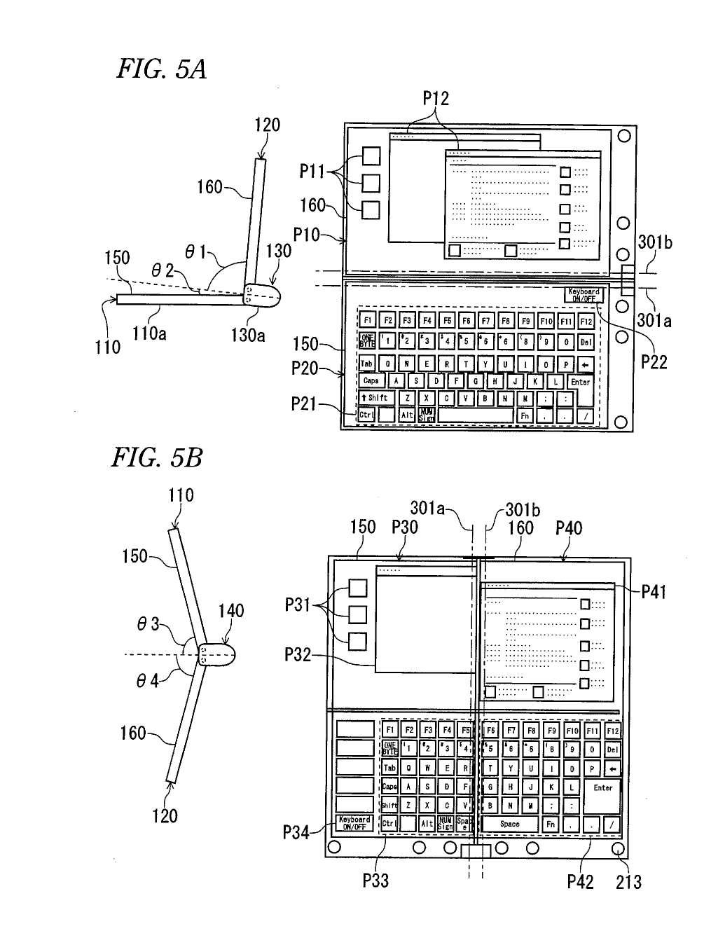

A result of determining the angle is input from the angle determining module 401 to the controller 402. Then, the controller 402 performs different processing according to the input result of determining the angle. If the result of determination is input thereto, which indicates that a sum of the opening angles of the first casing 110 and the second casing 120 is equal to or more than a certain angle, and that the difference in opening angle between the first casing 110 and the second casing 120 is equal to or more than a certain angle, the controller 402 causes the computer 100 to perform processing in a first PC mode. In the first PC mode, a keyboard image is displayed on the display panel at the side of the casing having a smaller opening angle, which is one of the first casing 110 and the second casing 120. A desktop screen and an application window screen are displayed on the display panel at the side of the other casing. That is, when the first PC mode is implemented, the controller 402 instructs the GUI generator 403 to generate a first PC mode screen. The details of an example of the configuration of the first PC mode screen are described below with reference to FIG. 5A.

When the angle determining module 401 inputs to the controller 402 a result of the determination, which indicates, e.g., that a sum of the opening angles of the first casing 110 and the second casing 120 is equal to or more than a certain angle, and that the difference in opening angle between the first casing 110 and the second casing 120 is less than a certain angle, the controller 402 causes the computer 100 to implement one of a second PC mode, a book mode, and a photo stand mode. However, the computer 100 can determine, according to, e.g., a setting operation input from a user, one of the modes as a mode to implement. If the computer 100 receives an operation input to a mode switching button 213 when one of the modes is implemented, the computer 100 can be transited to another mode.

The second PC mode is a display mode in which a screen is displayed on each of the first display panel 150 and the second display panel 160 in a direction differing from that in the first PC mode. In the second PC mode, the desktop screen is displayed on both the first display panel 150 and the second display panel 160. In addition, the keyboard image is displayed on both the first display panel 150 and the second display panel 160. Meanwhile, the details of an example of the configuration of the second PC mode screen are described below with reference to FIG. 5B.

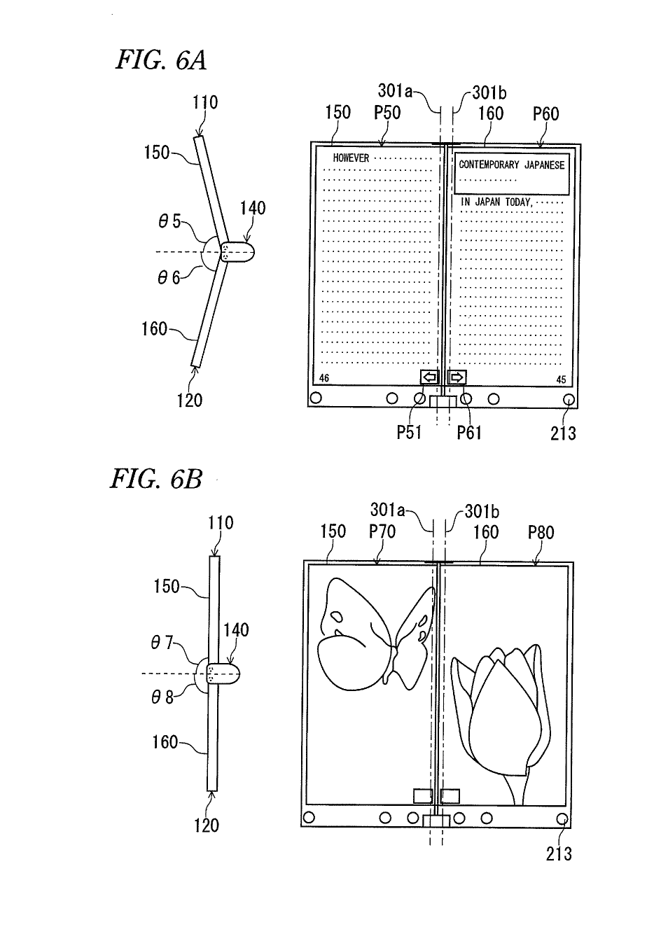

The book mode is a display mode in which, e.g., electronic book contents are displayed. The controller 402 implements a display in the book mode by executing a book display program (not shown) stored in, e.g., the HDD 207. The details of an example of the configuration of a book mode screen are described below with reference to FIG. 6A.

The photo stand mode is a display mode in which an image of a photograph stored in the HDD 207 is displayed on the entire screen of each of the first display panel 150 and the second display panel 160. The controller 402 implements a display in the photo stand mode by executing, e.g., an image display program (not shown) stored in the HDD 207. Incidentally, the details of an example of the configuration of a photo stand mode screen are described below with reference to FIG. 6B.

The GUI generator 403 generates GUI corresponding to an instruction from the controller 402, and outputs the generated GUI to the GPU 204. Thus, the first display panel 150 and the second display panel 160 are caused to display images.

Next, examples of screens generated and displayed in the first PC mode and the second PC mode by the computer 100 are described hereinafter with reference to FIGS. 5A and 5B. FIG. 5A illustrates an example of a screen that is generated by the GUI generator 403 and displayed by the first display panel 150 and the second display panel 160 in a case where an opening angle θ2 of the first casing 110 is less than that θ1 of the second casing 120 by a certain angle or more, i.e., in the case of the first PC mode. In the second PC mode, the first display panel 150 and the second display panel 160 display a screen including images of characters and the like such that the screen is directed in an orientation corresponding to a direction perpendicular to the axes 301a and 301b. That is, images of characters and the like are arranged in an orientation along the direction of a shorter side of the first display panel 150 on a screen P20 displayed on the first display panel 150. Similarly, images of characters and the like are arranged in an orientation along the direction of a shorter side of the second display panel 160 on a screen P10 displayed on the second display panel 160.

An icon image P11 for receiving an operation of accessing various applications and files, and an application window image P12 concerning an application that is being executed are arranged on the screen P10. A keyboard image P21 for receiving a key input from a user, and a switch image P22 for receiving an operation of switching between the display and the non-display of the keyboard image are arranged on the screen P20. Incidentally, when the angle determining module 401 inputs to the controller 402 a result of the determination indicating that the difference in opening angle between the first casing 110 and the second casing 120 is equal to or more than a certain angle, the controller 402 causes the display panel provided on the casing having a larger opening angle to display the screen P10, and also causes the display panel provided on the casing having a smaller opening angle to display the screen P20. When the resistance torque of turn of the first casing 110 with respect to the connection member 130 differs from that of turn of the second casing 120 with respect to the connection member 130, the controller 402 can allow the display panel at the side of the casing having larger resistance torque to preferentially display the screen P20. When the first touch panel 150a and the second touch panel 160a receive touch operations performed on such images, the controller 402 performs processing corresponding to each of the images that receive the operations.

That is, when, e.g., the first touch panel 150a receives an operation performed on one of the key images included by the keyboard image P21, the controller 402 outputs to the operating system a keycode corresponding to the key image. When the first touch panel 150a receives a touch operation performed on the switch button P22, the controller 402 instructs the GUI generator 403 to stop the generation of the keyboard image P21. If the keyboard image P21 is not displayed, the first display panel 150 can display a desktop image on the screen thereof. That is, the computer 100 can display the desktop image and the icon image P11 and the window image P12 superposed on the desktop image on each of both the first display panel 150 and the second display panel 160.

Meanwhile, a left-side part of FIG. 5A illustrates a state in which the first casing 110 is opened with respect to the connection member 130. However, the computer 100 can implement the first PC mode in a state in which the first casing 110 is not opened, i.e., a case where the angle θ2 illustrated in FIG. 5A is 0. If the computer 100 is installed on the flat surface of the external installation place, both the outer surface 110a of the first casing 110 and the side surface portion 130a of the connection member 130 are contacted with the flat surface of the external installation place.

FIG. 5B illustrates an example of a screen that is generated by the GUI generator 403 and displayed by the first display panel 150 and the second display panel 160 in a case where an opening angle θ3 of the first casing 110 is equal to or less than that θ4 of the second casing 120 by a certain angle, i.e., in a case where the second PC mode is set in the computer 100. In the second PC mode, the first display panel 150 and the second display panel 160 display a screen including an image of characters and the like such that the screen is directed in an orientation corresponding to a direction parallel to the axes 301a and 301b. That is, an image of characters and the like is arranged in an orientation along the direction of a longer side of the panel 150 on a screen P30 displayed on the first displayed panel 150. Similarly, images of characters and the like are arranged in an orientation along the direction of a longer side of the second display panel 160 on a screen P40 displayed on the second display panel 160.

An icon image P31, an application window image P32, a keyboard image P33, and a switch image P34 are arranged on the screen P30. An application window image P41, a keyboard image P42, and the like are arranged on the screen P40. When the first touch panel 150a and the second touch panel 160a receive touch operations performed on these images, the controller 402 performs processing according to each of the images receiving the operations.

That is, when, e.g., the first touch panel 150a receives a touch operation performed on the switch image P34, the controller 402 instructs the GUI generator 403 to stop the generation of the keyboard images P33 and P42. If the keyboard images P33 and P42 are not displayed, the first display panel 150 and the second display panel 160 can display a desktop image on a screen range on which the keyboard images are displayed. The controller 402 can instructs the GUI generator 403 to display the application window images P32 and P41, the entirety of which is displayed within one display panel.

Next, an example of a screen generated and displayed in the book mode and the photo stand mode by the computer 100 with reference to FIGS. 6A and 6B. FIG. 6A illustrates an example of a screen generated by the GUI generator 403 and displayed by each of the first display panel 150 and the second display panel 160 in a case where the difference between the opening angle θ5 of the first casing 110 and the opening angle θ6 of the second casing 120 is equal to and less than a certain angle and where the book mode is set in the computer 100. In the book mode, each of the first display panel 150 and the second display panel 160 display a screen including images of characters and the like in an orientation corresponding to a direction parallel to the axes 301a and 301b. That is, images of characters and the like are arranged in an orientation along a longer side of each of the first display panel 150 and the second display panel 160 on each of the screens P50 and P60 respectively displayed by the panels 150 and 160.

Images of characters and photographs, such as book contents, are arranged on each of the screens P50 and P60. Page moving images P51 and P61 for receiving operations of displaying the next page or the precedent page of the contents are arranged on the screens P50 and P60, respectively. In the book mode, the computer 100 can display not only one of the contents, as illustrated in FIG. 6A, but a list of plural contents stored in, e.g., the HDD 207. In addition, the computer 100 can receive a selection operation of determining what content is displayed. If each of the angles θ5 and θ6 is less than a certain angle, the computer 100 can vary the luminance of images displayed on the first display panel and the second display panel with regions on these panels. If the opening angles of the first casing 110 and the second casing 120 are less than a certain angle, sometimes, the screen appears dark due to insufficient outside light at a side thereof close to the connection member 130. Thus, the computer 100 can control the luminance of a region in each of the first display panel 150 and the second display panel 160 such that the closer the region to the connection member 130, the higher the luminance of the region becomes. That is, the first display panel 150 displays, in a neighborhood region of the axis 301a on the screen of the display panel 150, an image higher in luminance than the image displayed in a region more distant from the axis 301a than the neighborhood region.

FIG. 6B illustrates an example of a screen displayed by each of the first display panel 150 and the second display panel 160 in a case where the difference between the opening angle θ7 of the first casing 110 and the opening angle θ8 of the second casing 120 is less than a certain angle and where the photo stand mode is set in the computer 100. In the photo stand mode, the first display panel 150 and the second display panel 160 displays an image in an orientation corresponding to the direction parallel to the axes 301a and 301b.

Still-images and moving-images are stored in the HDD 207 are displayed on each of the screens P70 and P80. However, the computer 100 can display still-images and moving-images over the screens P70 and P80. Alternatively, the computer 100 can display an image so that the entire image is fit into each screen. In addition, the computer 100 can perform the slide-show display of plural still-images and moving-images stored in the HDD 207 by sequentially displaying the images every certain period.

The various display modes illustrated in FIGS. 5B, 6A and 6B can be switched in response to an operation input to, e.g., the mode switch button 213.

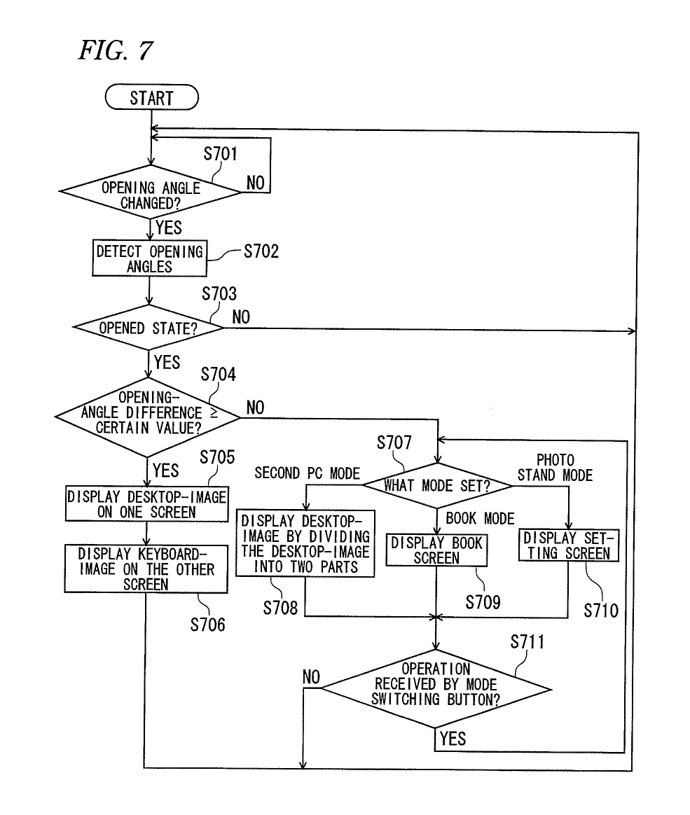

Next, an example of a flow of screen display processing by the computer 100 is described hereinafter with reference to FIG. 7. First, if the opening angle of at least one of the first casing 110 and the second casing 120 is changed in step S701, the angle detecting module 208 detects the opening angles of the first casing 110 and the second casing 120, and outputs information representing the detected angles to the angle determining module 401 in step S702. If the computer 100 is a closed state (No in step S703), the computer 100 is transited into a standby mode, and performs processing in step S701 again. Incidentally, the closed state is a state in which, e.g., a sum of the operating angle of the first casing 110 with respect to the connection member 130 and that of the second casing 120 with respect to the connection member 130 is less than a certain angle. In the standby mode, the computer 100 restricts the supply of electric-power to, e.g., the first display panel 150 and the second display panel 160.

On the other hand, if the computer 100 is in an opened state in step S703 (Yes in step S703), i.e., if the sum of the operating angle of the first casing 110 with respect to the connection member 130 and that of the second casing 120 with respect to the connection member 130 is equal to or more than the certain angle, in step S704, the angle determining module 401 determines whether the difference in opening angle between the first casing 110 and the second casing 120 is equal to or more than a certain angle. If the difference in opening angle therebetween is equal to or more than the certain angle (Yes in step S704), the controller 402 transits the running state of the computer 100 into the first PC mode. That is, the controller 402 causes the display panel at the side of the casing having a larger opening angle in step S705 to display a desktop image, and also causes the display panel at the side of the casing having a smaller opening angle in step S706 to display a keyboard image.

If the difference in opening angle between the casings is less than the certain angle in step S704 (No in step S704), in step S707, the controller 402 determines which of the modes is set. If the second PC mode is set (a second PC mode branch of step S707), the computer 100 is transited to the second PC mode, and displays a screen illustrated in FIG. 5B. That is, in step S708, the computer 100 divides the desktop image into parts and causes both of the first display panel 150 and the second display panel 160 to display the parts, respectively. On the other hand, if the book mode is set in step S707 (a book mode branch of step S707), in step S709, the computer 100 displays a screen on which, e.g., book contents and a list as illustrated in FIG. 6A. If the photo stand mode is set in step S707 (a photo stand mode branch of step S707), in step S710, the computer 100 displays a screen illustrated in FIG. 6B. Then, if the mode switching button 213 receives an operation input performed thereon while one of the modes respectively corresponding to step S708, S709, and S710 is implemented (Yes in Step S711), in step S707, the computer 100 switches the mode in response to the operation input.

According to this flow, if the difference in opening angle between the casings is equal to or more than a certain value, the computer 100 displays images in an orientation along a direction perpendicular to the axes 301a and 301b, i.e., the direction of a shorter side of each display panel. In this case, the computer 100 can display, according to the magnitude relation between the opening angles of the casings, images whose orientations differ from each other by 180 degrees. However, if the difference in opening angle between the casings is less than the certain value, the computer 100 displays images in an orientation along a direction parallel to the axes 301a and 301b, i.e., the direction of a longer side of each display panel. That is, the computer 100 displays images on the first display panel 150 and the second display panel 160 by changing, according to the opening angles of the respective casings, the orientation of the images by 90 degrees or 270 degrees.

In the above embodiments, the display processing has been described, in which different images are displayed according to both the opening angle of the first casing 110 and that of the second casing 120. However, the computer 100 can perform, according to the opening angles of the casings, processing other than the above display processing. That is, e.g., a touch pad or the like can be provided on an outer surface of the connection member 130, and the on/off of the touch pad can be controlled according to the difference in opening angle between the casings. If the difference in opening angle between the casings is large, i.e., in the first PC mode, the computer 100 is considered to be placed on a mounting surface. Thus, the touch pad is turned off. On the other hand, if the difference in opening angle between the casings is small, the computer 100 is considered to be grasped and used by a user. Thus, users' convenience can be enhanced by turning on the touch pad.

### Other Embodiments

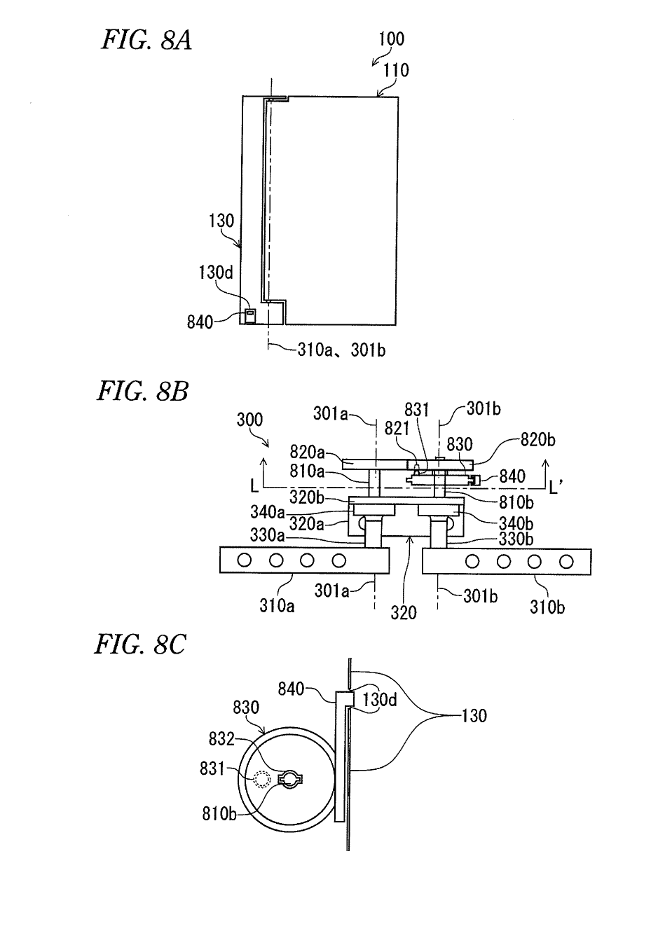

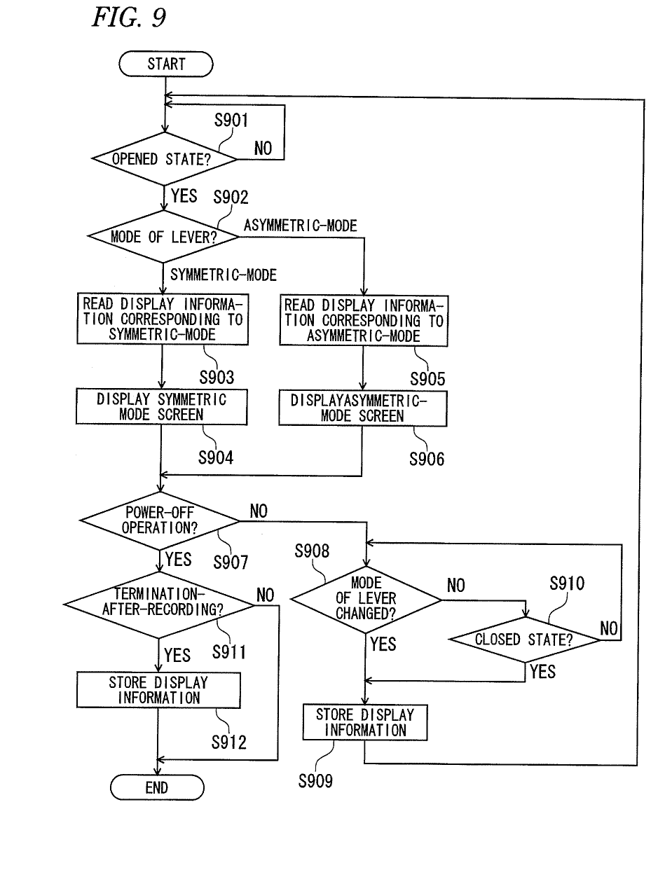

Next, a second embodiment is described hereinafter by mainly referring to FIGS. 8A to 8C and 9.

FIG. 8A is a diagram illustrating an example of an external-appearance of the computer 100 according to the second embodiment. The computer 100 includes a hole part 130d provided in the connection member 130 and a switching lever 840 provided in the hole part 130d, in addition to components described with reference to FIGS. 1A to 7.

A switching lever 840 is a lever (switch) for controlling the opening angles of the first casing 110 and the second casing 120 of the computer 100. The switching lever 840 restricts the opening/closing operations of the first casing 110 and the second casing 120 such that the opening angle of the first casing 110 with respect to the connection member 130 and the opening angle of the casing 120 with respect thereto are symmetrical with respect thereto, or that the opening angle of the first casing 110 with respect to the connection member 130 and the opening angle of the casing 120 with respect thereto are asymmetrical with respect thereto. That is, the switching lever 840 switches, in response to an operation input from a user, between a state (symmetric mode) in which each opening/closing operation of the first casing 110 is symmetric with that of the second casing 120, and a state (asymmetric mode) in which each opening/closing operation of the first casing 110 is asymmetric with that of the second casing 120.

FIG. 8B is a diagram illustrating an example of a structure associated with the switching lever 840. The switching lever 840 is connected to the configuration of the connection mechanism 300 described with reference to, e.g., FIGS. 2A and 2B.

The rotary drive force of the shaft 330a is transmitted to a shaft 810a whose axis is the same as that 301a of the shaft 330a. Incidentally, the shaft 330a can be the same as, e.g., the shaft 810a. Alternatively, the structure can be configured such that the rotary drive force of the shaft 330a is transmitted to the shaft 810a via a gear or the like. In addition, a gear 820a is fixed to the shaft 810a. The gear 820a is configured to mesh with a gear 820b (the teeth of the gears 820a and 820b are not shown).

A shaft 810b is configured similarly to the shaft 810a such that the rotary drive force of the shaft 330b is transmitted thereto via the same shaft as the shaft 330b or a gear. The gear 820b is rotatably connected to the shaft 810b. That is, the gear 820b rotates using the shaft 810b as a rotation axis, differently from the gear 820a. The gear 820b is provided with a concave part 821 engageable with a convex part 831 that will be described below.

The shaft 810b is provided with an engaging part 830 movably in the direction of an axis of the shaft 810b. The engaging part 830 is provided to suppress the rotation of the shaft 810b around the shaft axis thereof. The engaging part 830 includes the convex part 831 that can be fit into the concave part 821 when the engaging part 830 is located at the side of the gear 820b.

FIG. 8C illustrates an example of the structure associated with the engaging part 830. The engaging part 830 includes an opening part 832. The shaft 810b penetrates in the opening part 832. The concave part of the opening part 832 engages with the convex part of the shaft 810b. Thus, the rotation of the engaging part 830 around the shaft 810b is suppressed. The position of the engaging part 830 on the shaft 810b is controlled according to the position of the switching lever 840. The engaging part 830 is held at one of a position at which the engaging part 830 engages with the gear 820b, and a position at which the engaging part 830 doesn't engage with the gear 820b.

When the concave part 821 of the gear 820b engages with the convex part 831 of the engaging part 830, a rotary drive force of each of the shafts 810a and 810b is transmitted to the other by the gears 820a and 820b that mesh with each other. When these shafts rotate, the shafts rotate the same rotation angle. That is, if one of the first casing 110 and the second casing 120 turns when the concave part 821 and the convex part 831 engage with each other, the other casing turns the same angle.

The concave part 821 and the convex part 831 are configured to engage with each other when the opening angle of the first casing 110 with respect to the connection member 130 is equal to that of the second casing 120 with respect thereto. Thus, when the concave part 821 and the convex part 831 engage with each other, the first casing 110 and the second casing 120 are opened and closed by maintaining the opening angles thereof, which are symmetric with each other with respect to the connection member 130. That is, the switching lever 840 switches, according to the position thereof, between a state (symmetric mode) in which each opening/closing operation of the first casing 110 is symmetric with that of the second casing 120, and a state (asymmetric mode) in which each opening/closing operation of the first casing 110 is asymmetric with that of the second casing 120. For example, the switching lever 840 outputs a signal according to the position thereof to the angle determining module 401. The angle determining module 401 can determine, based on the signal, which of the position corresponding to the symmetric mode and that corresponding to the asymmetric mode the position of the switching lever 840 is.

Next, a flow of screen display processing by the computer 100 according to the second embodiment is described hereinafter with reference to FIG. 9. According to the present embodiment, when the symmetric mode or the asymmetric mode is transited to a different mode, the computer 100 stores contents displayed before the mode-transition. When the mode is returned to an original one, the computer 100 displays the contents displayed before the transition, based on the stored contents.

According to this flow, first, in step S901, the angle detecting module 208 determines whether at least one of the first casing 110 and the second casing 120 is opened. If at least one of the first casing 110 and the second casing 120 is in an opened state (Yes in step S901), in step S902, the angle determining module 401 determines which of the position corresponding to the symmetric mode and that corresponding to the asymmetric mode the position of the switching lever 840 is. If the lever 840 is in the symmetric mode (a symmetric branch of step S902), in step S903, the controller 402 reads display information in the symmetric mode, which is stored in the HDD 207.

This display information is information concerning previous contents displayed in the symmetric mode and includes information concerning, e.g., the processing state of an application, and the window positions and the sizes of applications. In addition, the display information can include the content name, the address, the playback position, and the like of content data such as a moving image. In step S904, the GUI generator 403 generates a screen based on the read display information and causes the first display panel 150 and the second display panel 160 to display an image. If the read display information includes the content name, the address, and the reproducing position of content data, the playback of the content data can be resumed from the playback position based on such information. Screens displayed in the symmetric mode are, e.g., those illustrated in FIGS. 5B, 6A, and 6B. The displayed screen corresponds to the reception of an operation performed on the mode switching button described with reference to, e.g., FIG. 7.

On the other hand, if the position of the switching lever 840 is that corresponding to the asymmetric mode in step s902 (an asymmetric mode branch in step S902), in step S905, the controller 402 reads asymmetric mode display information stored in the HDD 207. This display information is information concerning the previous contents displayed in the asymmetric mode, and includes the processing state, the window position, and the size of an application, the playback content name, the content address, the playback position (such as the playback position of a moving image, and the number of pages of book contents). Then, in step S906, the GUI generator 403 generates an asymmetric mode screen based on the read display information, and causes the first display panel 150 and the second display panel 160 to display the asymmetric mode screen. The screen displayed in the asymmetric mode is, e.g., the screen illustrated in FIG. 5A.

Next, if an operation of turning off a power supply is not received (No in step S907), in step S908, the computer 100 determines whether the position of the switching lever 840 is changed. If the position of the switching lever 840 is changed from one of the positions respectively corresponding to the symmetric mode and the asymmetric mode to that corresponding to the other mode (Yes in step S908), in step S909, the controller 402 causes the HDD 207 to store display information representing display contents currently displayed on the first display panel 150 and the second display panel 160. Then, the computer 100 performs processing in step S901. Incidentally, a storage medium caused to store display information is not necessarily the HDD 207 but can be, e.g., a volatile memory incorporated in the computer 100 or a removable medium. When display information is read in step S903 and S905, the display information can be read from a location at which the display information is stored in step S909.

On the other hand, even if the position of the switching lever 840 is not changed in step S908 (No in step S908), and if both the first casing 110 and the second casing 120 are closed (Yes in step S910), the computer 100 performs processing in step S909 to store the display information. Then, the computer 100 returns to step S901 to perform the processing.

If receiving an operation of turning off the power supply of the computer 100 in step S907 (Yes in step S907), in step S911, the computer 100 determines whether the setting of termination-after-recording has been performed. The setting of termination-after-recording is to set whether currently displayed contents are stored similarly to step 909 when the computer is shut down. If the setting of termination-after-recording is performed (Yes in step S911), in step S912, the display information is stored. Then, the computer 100 is shut down. Thus, this processing flow is completed.

According to this flow, the storing, reading and displaying of display information are controlled according to the switching between the symmetric mode and the asymmetric mode with the switching lever 840. However, such processing can be applied to the processing according to the first embodiment. That is, the apparatus can be configured as follows. In step S704 of the processing flow illustrated in FIG. 7, it is determined whether the difference in opening angle between the casings is equal to or more than the certain value. According to change of a result of the determination in step S704, the display information in each display mode, such as the first PC mode, the second PC mode, the book mode, and the photo stand mode, is stored. When the apparatus is returned to a display mode, the display information corresponding to this display mode is read and displayed.

Although a pressure detection type module is illustrated in FIGS. 2A and 2B as an example of the angle detecting module 208 in the first embodiment, the configuration of the angle detecting module 208 according to the embodiment is not limited thereto. For example, a conventional rotary encoder can be used as the angle detecting module 208.

While certain embodiments have been described, these embodiments have been presented by way of example only, and are not intended to limit the scope of the invention. Indeed, the novel apparatus and method described herein may be embodied in a variety of other forms; furthermore, various omissions, substitutions and changes in the form of the apparatus and method, described herein may be made without departing from the sprit of the invention. The accompanying claims and their equivalents are intended to cover such forms or modifications as would fall within the scope and sprit of the invention

1. An information processing apparatus comprising:
a connection member;
a first casing connected to the connection member turnably around a first axis;
a second casing connected to the connection member turnably around a second axis parallel to the first axis; and
a display panel provided on the first casing and configured to display an image according to both of a first turning angle of the first casing with respect to the connection member and a second turning angle of the second casing with respect to the connection member.

2. The apparatus of claim 1, wherein the display panel is configured to display an image according to a difference between the first turning angle and the second turning angle.

3. The apparatus of claim 2, wherein the display panel is configured to display an image by changing an orientation of the image by 90 degrees or 270 degrees according to the difference.

4. The apparatus of claim 2, wherein a display screen of the display panel comprises a rectangular shape, and
wherein when the difference is equal to or more than a certain angle, the display panel is configured to display an image whose orientation corresponds to a direction of a shorter side of the display screen.

5. The apparatus of claim 2, wherein a display screen of the display panel comprises a rectangular shape, and
wherein when the difference is neither equal to nor more than a certain angle, the display panel is configured to display an image whose orientation corresponds to a direction of a longer side of the display screen.

6. The apparatus of claim 2, wherein the display panel is configured to display images corresponding to different display modes according to the difference.

7. The apparatus of claim 2, further comprising:
a second display panel provided on the second casing; and
a touch panel provided to be superposed on the second display panel and configured to detect an external touch operation,
wherein the second display panel is configured to display a keyboard image if the first turning angle is larger than the second turning angle by a certain angle or more.

8. The apparatus of claim 2, wherein if the difference is neither equal to nor more than a certain angle, the display panel is configured to display, on a neighborhood region of the first axis on the display panel, an image whose luminance is higher than that of an area which is more distant from the first axis than the neighborhood region.

9. An information processing apparatus comprising:
a connection member;
a first casing connected to the connection member turnably around a first axis;
a second casing connected to the connection member turnably around a second axis parallel to the first axis; and
a controller configured to perform processing according to both of a first turning angle of the first casing with respect to the connection member and a second turning angle of the second casing with respect to the connection member.

10. An information processing method for use in an apparatus comprising a connection member, a first casing connected to the connection member turnably around a first axis, a second casing connected to the connection member turnably around a second axis parallel to the first axis, and a display panel provided on the first casing, the information processing method comprising:
detecting a first parameter concerning a turning angle of the first casing with respect to the connection member;
detecting a second parameter concerning a turning angle of the second casing with respect to the connection member; and
displaying an image on the display panel according to both of the detected first parameter and the detected second parameter.

11. The apparatus of claim 1, further comprising:
a restricting member configured to restrict the first turning angle and the second turning angle to corresponding angles,
wherein the display panel is configured to display a first image when the restricting member restricts the first turning angle and the second turning angle and to display a second image different from the first image when the restricting member does not restrict the first turning angle and the second turning angle.

12. The apparatus of claim 11, further comprising:
a switching member configured to switch between enablement and disablement of the restriction by the restricting member.

13. The apparatus of claim 12, further comprising:
a storage module configured to control a storage medium to store display information concerning an image displayed on the display panel when a state of the apparatus is changed from one of a first state and a second state to the other, the first state being a state in which a difference between the first turning angle and the second turning angle is equal to or more than a certain value, the second state being a state in which the difference is less than the certain value,
wherein when the state of the apparatus is changed to the other of the first state and the second state from the one after the display information is stored in the storage medium, the display panel is configured to display an image based on the display information.
